(19) United States
(12) Patent Application Publication
(10) Pub. No.: US 2007/0220947 A1
(43) Pub. Date: Sep. 27, 2007

(54) Method for regulating and monitoring a measuring system, and measuring system itself

(76) Inventors: Dieter Keese, Wahlsburg (DE); Holger Seebode, Goettingen (DE)

Correspondence Address: ABB Inc.;Legal Dept. - 4U6, 29801 Euclid Avenue, Wickliffe, OH, 44092-1832, US

(21) Appl. No.: 11/643,299

(22) Filed: Dec. 21, 2006

(30) Foreign Application Priority Data
Dec. 23, 2005 (DE) DE 102005062105.8
Feb. 10, 2006 (DE) DE 102006006152.7

(51) Int. Cl. G01F 25/00

(52) U.S. Cl. 73/1.16

(57) ABSTRACT

The invention relates to a method for regulating and monitoring a measuring system, in particular a flow measuring device, and the flow measuring device itself according to the preamble of patent claims 1 and 3. In order to be able to determine operability trends, according to the invention at cyclic time intervals besides measuring the terminal voltage Uk and the terminal current Ik, in addition the ohmic impedance, the inductance, the value of the reference resistor and the magnetization current are measured at cyclically recurring intervals, compared with reference values from a previous calibration measurement and stored.

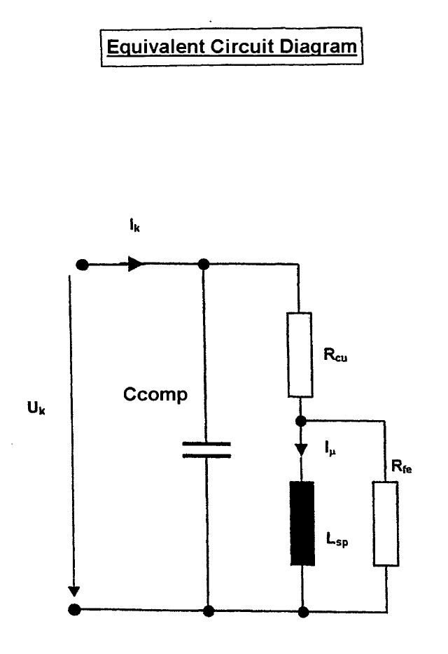

### CROSS REFERENCE TO RELATED APPLICATIONS

This application claims priority from German Application Nos. DE 10 2005 062 105.8 filed on Dec. 23, 2005 and DE 10 2006 006 152.7 filed on Feb. 10, 2006 the contents of which are relied upon and incorporated herein by reference in their entirety, and the benefit of priority under 35 U.S.C. 119 is hereby claimed.

### BACKGROUND OF THE INVENTION

The invention relates to a method for regulating and monitoring a measuring system, in particular a flow measuring device, and the flow measuring device itself.

The method for operating an inductive flow measuring instrument with a magnet system, which is excited by a sinusoidal AC voltage, is a method in which the measuring system is monitored.

The equivalent circuit diagram of the signal-generating magnet system of a magnetically inductive flow meter (IFM) is represented below.

In order to minimize the power losses, reactive current compensation is carried out by means of a capacitor.

Mathematical observation:
\sqrt{E}=\sqrt{v}×\sqrt{B} Initial equation:

Equation after simplification: Uo=kvBD

### SUMMARY OF THE INVENTION

It is therefore an object of the invention to develop a method and a measuring system so that it is proof from external interfering effects.

### BRIEF DESCRIPTION OF THE DRAWING

The Figure shows an equivalent circuit diagram of a measuring system.

For a method of the species, said object is achieved according to the invention in that besides measuring the terminal voltage Uk and the terminal current Ik, in addition the ohmic impedance, the inductance, the value of the reference resistor and the magnetization current are measured at cyclically recurring intervals, compared with reference values from a previous calibration measurement and stored.

### DETAILED DESCRIPTION OF ILLUSTRATIVE EMBODIMENTS

In this context, it is of considerable practical use for the data to be recorded as historical data and for an evaluation of the expectable operating failures or maintenance to be calculated from the development trends of the respectively said values as a whole.

In respect of a measuring system, said object is achieved according to the invention in that the sensors provided for measuring the terminal voltage Uk, the terminal current Ik, the ohmic impedance Rcu, the magnetization current Iu, the inductance Lsp and the reference resistance Rfe are measurable, as well as a timer which writes the respective currently measured values into a data storage device at cyclic intervals.

Here as well it is possible to be able to predetermine failure times of the system.

In order to develop a stable measuring system which is proof against environmental effects, it is necessary to keep the magnetization current and therefore the field strength B constant (at the optimal working point of the magnet system).

For direct determination of the field strength B, which is a factor influencing the measurement voltage Uo, it is possible to use an additional copper winding on the field-forming magnetic circuit.

Most currently used measuring systems deduce the field strength B by measuring the current Ik (voltage drop across a reference resistor).

However at the terminals it is only possible to measure the current Ik, phase-shifted relative to the magnetization current, and the terminal voltage Uk.

The phase shift between and the ratio of Ik and Iu can change because of environmental influences.
Rcu=copper resistance of the coil
L=inductance of the magnetic circuit
Rfe=iron losses
Ik=terminal current
Iu=magnetization current
Ccomp=compensation capacitor

The functional essence of the invention is that not only the terminal voltage Uk and the terminal current Ik are used for regulating and monitoring the measuring system. In order to identify changes in the system, the elements represented in the equivalent circuit diagram are determined cyclically so as to react accordingly where appropriate. It is therefore possible to keep the magnetization current Iu constant by regulating the value of Ik. The characteristic data of the individual values of the elements are stored as reference values during the calibration.

By comparing the measured values of the individual elements with the associated stored reference values and reference limits, the functional capability of the system can be determined and failures in the future can be inferred by trends.

The principle employed here is that Faraday's law of induction is used for measuring flow rates. If an electrically conductive substance to be measured is passed through a magnetic field B, then an electric field E is set up in the substance to be measured perpendicularly to the flow direction V and to the magnetic field direction E=V×B.

1. A method for regulating and monitoring a measuring system, in particular a flow measuring system, wherein besides measuring the terminal voltage Uk and the terminal current Ik, in addition the ohmic impedance, the inductance, the value of the reference resistor and the magnetization current are measured at cyclically recurring intervals, compared with reference values from a previous calibration measurement and stored.

2. The method as claimed in claim 1, wherein the data are recorded as historical data and an evaluation of the expectable operating failures or maintenance is calculated from the development trends of the respectively said values as a whole.

3. A measuring system, with regulation and monitoring thereof, in particular a flow measuring system, wherein the sensors for measuring the terminal voltage Uk, the terminal current Ik, the ohmic impedance Rcu, the magnetization current Iu, the inductance Lsp and the reference resistance Rfe are measurable, as well as a timer which writes the respective currently measured values into a data storage device at cyclic intervals.

4. The measuring system as claimed in claim 3, wherein the historically recorded data are evaluated inside an evaluation device, and expectable failure times can be calculated from the trends.
